(19) United States
(12) Patent Application Publication
(10) Pub. No.: US 2014/0164072 A1
(43) Pub. Date: Jun. 12, 2014

(54) System and Method for Quantified Quality Analysis and Benchmarking for Building Information Modeling

(71) Applicant: Solibri, Inc., Helsinki (FI)

(72) Inventors: Heikki Antero Kulusjarvi, Espoo (FI); Anupam Arohi, Espoo (FI); Pasi Tuomo Paasiala, Helsinki (FI); Matti Juhani Kannala, Espoo (FI)

(73) Assignee: Solibri, Inc., Helsinki (FI)

(21) Appl. No.: 14/099,607

(22) Filed: Dec. 6, 2013

Related U.S. Application Data
(60) Provisional application No. 61/734,148, filed on Dec. 6, 2012.

(51) Int. Cl. G06Q 10/06

(52) U.S. Cl. CPC G06Q 10/06393
USPC 705/7.39

(57) ABSTRACT

A system and method for providing reliable means of benchmarking quality for BIM models. The system and method can provide a concrete measurable means to the quality of a BIM model. The system also provides mechanism to see how a BIM model is in terms of its quality relative to other similar BIM models.

### CLAIM OF PRIORITY

This application claims priority from U.S. Provisional Patent Application 61/734,148, filed Dec. 6, 2012, which is relied upon and incorporated herein in its entirety by reference.

### FIELD OF THE INVENTION

The present invention relates generally to a system for BIM model quality checking and benchmarking. More specifically, the present invention relates to benchmarking BIM model quality and providing a graphical representation of relative model quality.

### BACKGROUND OF THE INVENTION

Building Information Modeling models are common communication means of information exchange between stakeholders in building projects. The BIM model is involved from inception of the development concept to the maintenance of completed facility. The BIM model is used to convey the design content. In many aspects, the BIM model can be conveyed in the form of 2D and 3D visual representations. FIG. 1 shows the typical visual representation of building components provided by BIM software.

BIM models are frequently monitored and evaluated for quality, i.e., to identify problems with design or ineffective construction methods. Current evaluation systems present number of issues, literally thousands, in a BIM model and details of individual issues. When BIM models are checked for quality, the stakeholders typically get a long list of issues. An example of such lists is shown in FIG. 1. Based on these long lists, assessing overall quality of the model is arduous.

Moreover, the number of issues has a different meaning for each stakeholder. Hence, there is no overall quality measure of a model. This information is difficult to interpret and benchmark against other similar models. Moreover, these results are not understood by all stakeholders in a same way and there is no clear picture on overall quality of a model hence no motivation to improve it. Besides, there is no automatic way to measure the relative quality of a model with respect to other similar models.

Therefore, there is a need to provide a measureable means to understand the level of problems in a model. In addition, there is a need to give a more concrete and accurate measure for benchmarking the quality of a model.

### SUMMARY OF THE PRESENT INVENTION

The present invention is aimed at providing measurable means in the evaluation of Business Information Modeling (BIM). In an exemplary aspect, the present invention is directed at a Quantified Quality Analysis and Benchmarking (QQAB) system that provides a measurable means for the evaluation of BIM models. By providing measureable means, the QQAB system makes it significantly easier to understand the level of problems in a BIM model. In an aspect, the QQAB system can utilize a cloud service to provide such evaluations.

In an aspect, the measurable means can be provided by defining the number of issues that are found in a BIM model per the unit volume to create an “issue density” for each BIM model. By helping to understand how many issues per unit volume there are in a BIM model, the QQAB System gives a more concrete and accurate measure for benchmarking the quality of a BIM model. Further, the invention also maintains a database or bank of quality measures of all assessed models. Hence, stakeholders/users could obtain a relative benchmark for an “ideal” and an “average” model. Stakeholders can compare the quality measures against similar measures produced from multiple similar BIM models.

In an aspect of the present invention, the QQAB system provides an efficient way to assess and improve quality of a BIM model. The QQAB system can provide mechanisms that facilitate the quality improvements of a BIM model and motivates stakeholders/users to make improvements by giving them a concrete measure on which to focus. While the QQAB system is most pertinent to BIM modeling process, it is not limited to only such uses.

In an exemplary aspect, the QQAB system is a collaborative system that can leverage internet cloud based technologies. In such aspects, the QQAB system can utilize a single or multiple servers that can be accessed remotely by a plurality of remote devices that generate BIM models. In such aspects, the QQAB system can store a collection of BIM model quality test results and respective tags utilized to describe the BIM models and the BIM model components. Users/stakeholders can register a BIM model's quality test results. In an aspect the quality test results can include an issue density. In such aspects, the stakeholder/user can also tag the BIM models to be able to classify the BIM model into more specific categories. Based on BIM model tags, the QQAB system relates a given BIM model with other BIM models. The QQAB system also provides a mechanism to obtain a quality benchmark of a BIM model relative to other similar models.

In an aspect, a user/stakeholder can create a BIM model using a BIM model application. In an exemplary aspect, the user can utilize a device capable of generating BIM models. Once the BIM model is created, the user can check the BIM model using a BIM quality check application. In an aspect, the BIM quality check application can then pass along the results to a benchmark application to create the issue density. In an aspect, the quality results and volume of the BIM model can be utilized to create the issue density for the BIM model. In another aspect, the BIM quality check application can capture or produce BIM model details like type of model, area of model, location of model etc., which can be provided by the user.

In an aspect, a user can call upon the benchmark application to call upon a QQAB server to compare the results to other BIM models. In an aspect, the user can register the BIM model's test results with the QQAB server and supply other details about the BIM model to describe/tag the BIM model during registration. Once the BIM model is registered, the user can query the QQAB server for benchmarking. The QQAB server can then processes the BIM model's issue density against other similar BIM models and prepares a visual graph. In an aspect, the QQAB server utilizes the tags assigned with the selected BIM model to identify and use similar BIM models for the benchmarking. In an aspect, the graph can utilize a standard bell curve where issue density is plotted using Gaussian function. In an aspect, the BIM model's issue density is distinctively marked on the graph indicating which part of the curve the BIM model belongs. If the BIM model benchmark obtained is not acceptable, the system provides the user/stakeholder with an opportunity to improve the BIM model design and repeat the iteration.

These and other objects and advantages of the invention will become apparent from the following detailed description of the preferred embodiment of the invention.

Both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

FIG. 1 is a screenshot of 3D BIM model data and quality analysis from BIM modeling and quality analysis software known in the prior art.

FIG. 2 is an architecture block diagram representation of a QQAB system according to an embodiment of the present invention.

FIG. 3 is an architecture block diagram representation of a BIM device of the QQAB system of FIG. 2 according to an embodiment of the present invention.

FIG. 4 is an architecture block diagram representation of a QQAB server of the QQAB system of FIG. 2 according to an embodiment of the present invention.

FIG. 5 is a schematic representation of components of the QQAB system of FIG. 2.

FIG. 6 is a depiction of a screenshot created by the QQAB system according to an embodiment of the present invention.

FIG. 7 is a flow chart depicting a method performed by the QQAB system according to an embodiment of the present invention.

FIG. 8 is a flow chart depicting a method performed by the QQAB system according to an embodiment of the present invention.

FIG. 9 depicts a screenshot of a user interface provided by the QQAB system according to an embodiment of the present invention.

FIG. 10 is a schematic representation of components of the QQAB system of FIG. 5.

FIG. 11 is a flow chart depicting a part of the method of FIG. 8 according to an embodiment of the present invention.

FIG. 12 is a schematic representation of components of the QQAB system of FIG. 5.

FIG. 13 depicts an example of a table of tags for BIM models according to an embodiment of the present invention.

FIG. 14 is a schematic representation of components of the QQAB system of FIG. 5.

FIG. 15 depicts an example of a table of BIM models and associated tags according to an embodiment of the present invention.

FIG. 16 depicts a screenshot of a user interface provided by the QQAB system according to an embodiment of the present invention.

FIG. 17 depicts an example of a table of BIM models and associated issue densities according to an embodiment of the present invention.

FIG. 18 depicts a screenshot of a user interface provided by the QQAB system according to an embodiment of the present invention.

FIG. 19 is a flow chart depicting a part of the method of FIG. 8 according to an embodiment of the present invention.

FIG. 20 depicts a screenshot of a user interface provided by the QQAB system according to an embodiment of the present invention.

FIG. 21 is a flow chart depicting a part of the method of FIG. 19 according to an embodiment of the present invention.

FIG. 22 depicts a screen shot of a benchmark supplied by QQAB system according to an embodiment of the present invention.

### DETAILED DESCRIPTION

The present invention will now be described more fully hereinafter with reference to the accompanying drawings, which are intended to be read in conjunction with this detailed description, the summary, and any preferred and/or particular embodiments specifically discussed or otherwise disclosed. This invention may, however, be embodied in many different forms and should not be construed as limited to the embodiments set forth herein. Instead, these embodiments are provided by way of illustration only and so that this disclosure will be thorough, complete and will fully convey the full scope of the invention to those skilled in the art.

### DEFINITIONS

The following terms are used throughout the specification and claims.

STAKEHOLDER/USER: Stakeholder/user is a person who plays a role in design and development of a facility. A stakeholder and/or user can include, but is not limited to, an owner or represent of the owner of the facility, an architect, mechanical engineer, electrical engineer, construction manager, civil engineer, interior designer, contractors and like.

BIM MODEL: Building Information Modeling (BIM) model is a digital representation of physical and functional characteristics of a facility, including, but not limited to buildings, plants, or infrastructure. A BIM model is a shared knowledge resource for information about a facility forming a reliable basis for decisions during its life-cycle, which is defined as existing from earliest conception to demolition. In use in this application, a BIM model can include all types of modeling information, and not just facilities. For example, the information can relate to product development modeling.

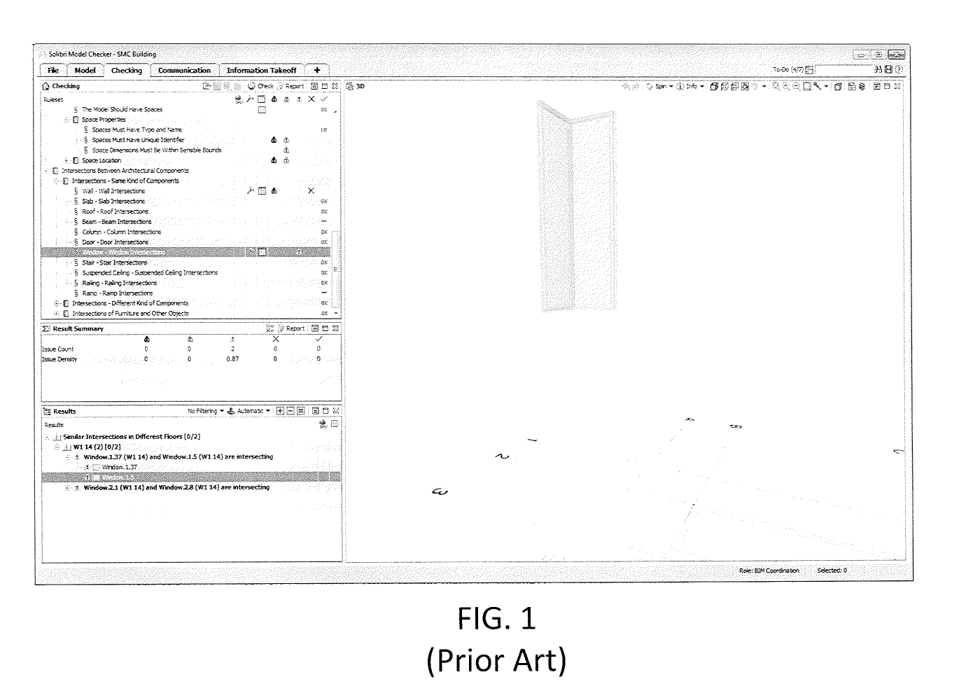

ISSUE: An issue is a defect that can lead to misconstruction or a situation where the actual construction would not be feasible. For example, as illustrated in FIG. 1, the windows are intersecting, which may lead to problems during actual installation of windows. More examples of issues include, but are not limited to, clashes (components interfering with other components); overlap (same kind of components e.g. wall overlapping each other in the model); number of components “missing” from the model (e.g. load bearing structures need components on the bottom (components are not hanging in the air) and need to support some component on top); components of certain type having different dimensions; number of code violence according to a specific building code; etc.

VOLUME: The “volume” of a BIM model is always available in some form either as the volume inside the envelope of the building or outer 3D structure of the pipe network makes a container and volume of this imaginary container.

AREA: Similar to volume, the “area” of a BIM model is always available in some form, either the area taken up by the base of the building.

ISSUE DENSITY: It is computed as number of issues per unit volume or area, depending on the unit used by the BIM model. For example, let us assume that we have a BIM model that represents a school building. Total volume of the building is 250,000 cubic feet. After analyzing this BIM model, there are 1000 issues detected, then issue density is computed as 1000/250,000=4.0 issues per 1000 cubic feet.

TAGS: A “tag” is a description that can be applied or associated to a BIM model. The tag describes certain aspects and/or qualities of the BIM model, including, but not limited to, the type of structure associated with the BIM model, the specific standards the BIM model must satisfy, and the like.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. In addition, the present methods and systems may be implemented by centrally located servers, remote located servers, or cloud services. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, computers and components found in cloud services, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, cloud services, mobile devices (e.g., smart phones, tablets, and the like) and multiprocessor systems. Additional examples comprise set top boxes, programmable consumer electronics, network PCs, minicomputers, mainframe computers, enterprise servers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

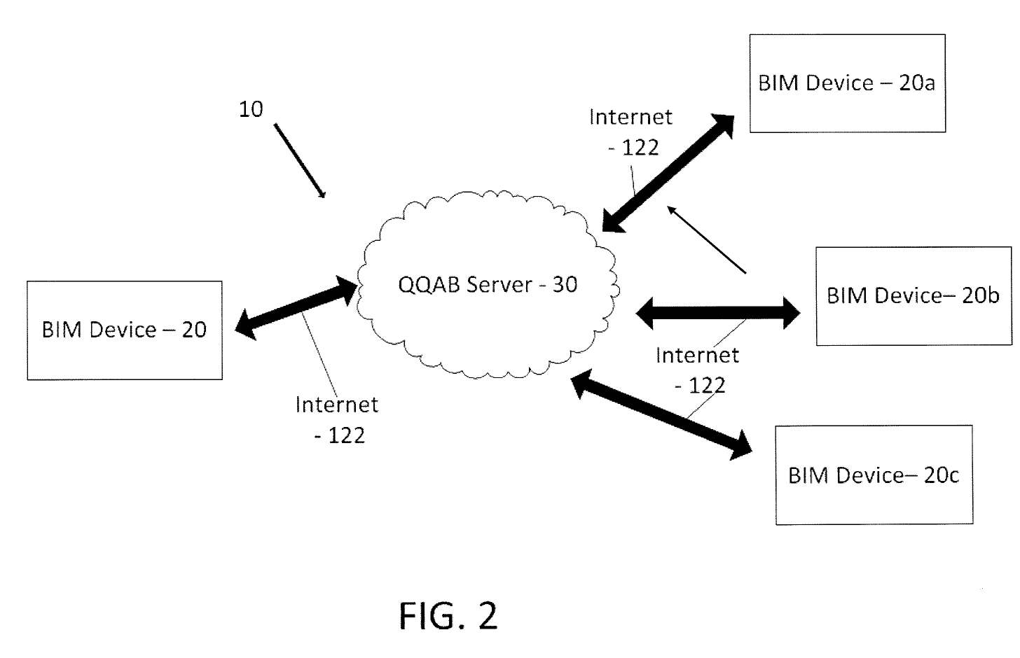

As illustrated in FIGS. 2-5, the present invention is directed to a Quantified Quality Analysis and Benchmarking (QQAB) system 10 configured to comparatively evaluate BIM models. In an aspect, the QQAB system 10 is configured to utilize BIM devices 20 and a QQAB server 30 to compare and evaluate BIM models. In an aspect, the BIM devices 20 can generate and evaluate the quality of a BIM model. The BIM devices 20 can then call upon the QQAB server 30 to evaluate the BIM model against other BIM models that have been previously evaluated. In an aspect, the QQAB system 10 utilizes cloud-based services provided by the QQAB server 30, with the BIM devices 20 able to communicate with the QQAB server over a network 122.

In an exemplary aspect, the QQAB system 10 is configured to handle BIM models associated with buildings and other types of facilities (e.g., schools, apartments, market complexes, factories, etc.). In other aspects, the QQAB system 10 can be used in product design and development, other industries which utilize modeling, and in any system where information comes from and is presented in distinct sources in a synchronized fashion.

As shown in FIGS. 2-4, the QQAB system 10 can utilize BIM devices 20. The BIM devices 20 are configured to produce BIM models for evaluation. In an aspect, the BIM devices 20 can obtain BIM models from other sources, or generate the BIM models themselves. In another aspect, the BIM devices 20 can be configured to evaluate the BIM models.

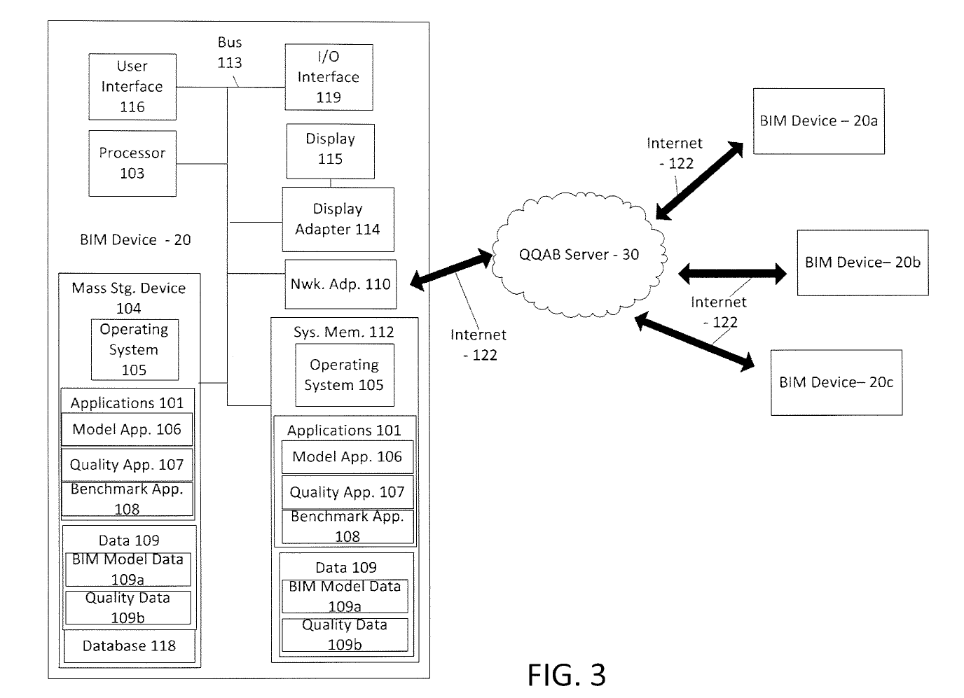

The BIM devices 20 can be implemented via a general-purpose computing device in the form of a computer 20 shown in FIG. 3. Referring to FIG. 3, the BIM device 20 may have several applications 101, including, but not limited to, a BIM modeling application 106 (Model App.—106), a BIM quality check application 107 (Quality App.—107), and a benchmark application 108 (Benchmark App.—108). In an aspect, while FIG. 3 illustrates the BIM device 20 and its applications 101 in the form of a general-purpose computing device, in other embodiments the BIM device 20 may utilize elements and/or modules of several nodes or servers that make up cloud services and the like. In any event, the BIM device 20 should be construed as inclusive of multiple modules, software applications, servers and other components.

The components of the BIM device 20, in addition to the applications 101, can comprise, but are not limited to, one or more processors or processing units 103, a system memory 112 (Sys. Mem.—112), and a system bus 113 that couples various system components including the processor 103 to the system memory 112. In the case of multiple processing units 103, the BIM device 20 can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104 (Mass Stg. Device 104), an operating system 105, applications 101, including, but not limited to, the BIM model application 106, the BIM quality check application 107, and the benchmark application 108, a network adapter 110 (Nwk. Adp. 110), system memory 112, an Input/Output Interface 119 (I/O Interface 119), a display adapter 114, a display device 115, and a user interface 116. As discussed above, these components can be contained within one or more remote computing devices at physically separate locations, connected through buses of this form, in effect implementing a fully distributed system.

The BIM device 20 typically comprises a variety of computer readable media. Exemplary readable media can be any available media that is accessible by the BIM device 20 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data 109. The data 109 can include BIM model information and/or program modules such as operating system 105, the BIM model application 106, the BIM quality check application 107, and the benchmark application 108 that are immediately accessible to and/or are presently operated on by the processing unit 103.

In an aspect, the data 109 can also include BIM model data 109a and quality data 109b. The BIM model data 109a can include the information specific to a BIM model. Such data 109 a includes, but is not limited to, the dimensions of the BIM model (e.g., volume, height, area, etc.), the components of the BIM model (e.g., walls, windows, doors, etc.) and their respective dimensions, the materials of the components, and the relationship between such components and the like. The quality data 109b can identify the problems of the BIM model. The quality data 109b can be generated by the BIM quality check application 107, discussed in more detail below.

In another aspect, the BIM device 20 can also comprise other removable/non-removable, volatile/non-volatile computer storage media. By way of example, FIG. 3 illustrates a mass storage device 104 which can provide non-volatile storage of computer code, computer readable instructions, data structures, including databases 118, program modules, and other data 109 for the BIM device 20. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105, the applications 101, including, but not limited to, the BIM model application 106, the BIM quality check application 107, and the benchmark application 108. Each of the operating system 105 and other applications 101(the BIM model application 106, the BIM quality check application 107, and the benchmark application 108,) (or some combination thereof) can comprise elements of the programming and the other applications, modules, and like described herein. Data 109, including BIM model data 109a and quality data 109b, can also be stored on the mass storage device 104. In another aspect, the data 109, including the BIM model data 109a and quality data 109b, can be stored as separate files. In another aspect, the data 109 can be stored in a database 118. BIM data 109 can be stored in any of one or more databases known in the art. The databases can be centralized or distributed across multiple systems.

In another aspect, the user can enter commands and information into the BIM device 20 via an input device (not shown). Examples of such input devices comprise, but are not limited to, a keyboard, pointing device (e.g., a “mouse”), a microphone, a joystick, a scanner, tactile input devices such as gloves, and other body coverings, and the like. Further examples can include image capturing devices, such as, but not limited to, optical coherence tomography capturing devices, fundus cameras, scanning laser ophthalmoscope, and other devices used to capture images and other information related to the monitoring and examination of eyes. These and other input devices can be connected to the processing unit 103 via a human machine user interface 116 that is coupled to the system bus 113, but can be connected by other interface and bus structures, such as a parallel port, game port, an IEEE 1394 Port (also known as a Firewire port), a serial port, or a universal serial bus (USB), or network connection.

In yet another aspect, a display device 115 can also be connected to the system bus 113 via an interface, such as a display adapter 114. It is contemplated that the BIM device 20 can have more than one display adapter 114 and the BIM device 20 can have more than one display device 115. For example, a display device can be a monitor, an LCD (Liquid Crystal Display), or a projector. In addition to the display device 115, other output peripheral devices can comprise components such as speakers (not shown) and a printer (not shown) which can be connected to the BIM device 20 via Input/Output Interface 119. Any step and/or result of the methods can be output in any form to an output device. Such output can be any form of visual representation, including, but not limited to, textual, graphical, animation, audio, tactile, and the like.

As illustrated in FIG. 3, the BIM devices 20 operate in a networked environment using logical connections 122 to the QQAB Server 30 and one or more remote BIM devices 20a,b,c. By way of example, the remote BIM devices 20a, 20b, 20c can be a personal computer, portable computer, a server, a router, a network computer, a wireless connected tablet or mobile device, a peer device or other common network node, and so on. The remote BIM devices 20a, 20b, 20c can be comprised of the same components discussed above. Logical connections between the BIM devices 20, 20a,b,c and the QQAB server 30 be made via a local area network (LAN) and a general wide area network (WAN), including, but not limited to, the Internet 122. Such network connections can be through a network adapter 110. A network adapter 110 can be implemented in both wired and wireless environments. Such networking environments are conventional and commonplace in offices, enterprise-wide computer networks, intranets, cellular networks and the Internet 122.

As shown in FIGS. 2-5, the QQAB system 10 can utilize a QQAB server 30. The QQAB server 30 is configured to evaluate the quality of BIM models against other comparable BIM models. In an aspect, the QQAB sever 30 obtains BIM models and related quality information from BIM devices 20, comprises a centralized database 218 of such BIM model data 210b and comparison (tag) data 210a, and provides means for stakeholders/users of the BIM devices 20 to compare respective BIM models against one another. In an aspect, the QQAB server 30 is further configured to provide means to inform the users of the BIM devices 20 on how the user's selected BIM model relates to various ranges of comparative BIM models.

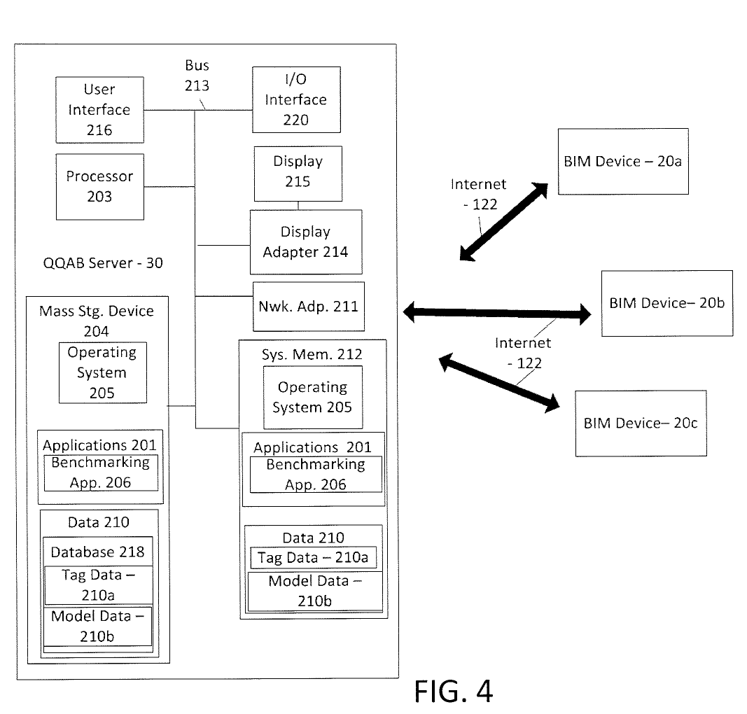

Referring to FIG. 4, the QQAB sever 30 can be implemented via a general-purpose computing device in the form of a computer server 30. In other aspects, the QQAB sever 30 can take the form of a cloud service 30. The QQAB server 30 and its applications may utilize elements and/or modules of several nodes or servers that make up cloud services and the like. In any event, the QQAB server 30 should be construed as inclusive of multiple modules, software applications, servers and other components that are separate from the BIM devices 20.

Referring to FIG. 4, the QQAB server 30 may have several applications 201, including, but not limited to, a benchmarking application 206. The components of the QQAB server 30, in addition to the applications 201, can comprise, but are not limited to, one or more processors or processing units 203, a system memory 212 (Sys. Mem.—212), and a system bus 213 that couples various system components including the processor 203 to the system memory 212. In the case of multiple processing units 203, the QQAB server 30 can utilize parallel computing. In an aspect, the system bus 213 of the QQAB server 30 can be similar to the different types of system buses 113 of the BIM devices 20 discussed above.

The bus 213, and all buses specified in this description, can also be implemented over a wired or wireless network connection and each of the subsystems, including the processor 203, a mass storage device 204 (Mass Stg. Device—204), an operating system 205, applications 201, including, but not limited to, the benchmarking application 201, a network adapter 211 (Nwk. Adp. 211), system memory 212 (Su. Mem. 212), an Input/Output (I/O) Interface 220, a display adapter 214, a display device 215, and a user interface 216. As discussed above, these components can be contained within one or more remote computing devices at physically separate locations, connected through buses of this form, in effect implementing a fully distributed system.

The QQAB server 30 typically comprises a variety of computer readable media. Exemplary readable media can be any available media that is accessible by the QQAB server 30 and comprises, for example and not meant to be limiting, both volatile and non-volatile media, removable and non-removable media. In an aspect, the system memory 212 of the QAB server 30 can be comprised of similar types of the system memory 112 of the BIM devices 20 discussed above. The system memory 212 typically contains data 210. The data 210 can include BIM model information and/or program modules such as operating system 205 and the benchmarking application 206 that are immediately accessible to and/or are presently operated on by the processing unit 203. In an aspect, the data 210 can include tag data 210a and BIM model data 210b, discussed in more detail below.

In another aspect, the QQAB server 30 can also comprise other removable/non-removable, volatile/non-volatile computer storage media. By way of example, FIG. 4 illustrates a mass storage device 204 which can provide non-volatile storage of computer code, computer readable instructions, data structures, including databases 218, program modules, and other data 210 for the QQAB server 30. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205, the applications 201, including, but not limited to, the benchmarking application 206. Each of the operating system 205 and other applications 201 can comprise elements of the programming and the other applications, modules, and like described herein. Data 210, including tag data 210a and BIM model data 210b, can also be stored on the mass storage device 204. In another aspect, the data 210 can be stored as separate files. In another aspect, the data 210 can be stored in a database 218. The data 210 can be stored in any of one or more databases known in the art. The databases can be centralized or distributed across multiple systems. As discussed in more detail below, the tag data 210a and the BIM model data 210b, which can include issue density, can be stored in a relational database 218.

In another aspect, a system administrator can enter commands and information into the QQAB server 30 through an input device (not shown). Such input devices can comprise, but are not limited to, those input devices discussed above in reference to the BIM device 20. In an aspect, the QQAB server 30 can receive commands and information inputted by the user through the BIM device 20 (i.e., the user enters the information/commands on the BIM device 20, which then passes along the command/information to the QQAB server 30). In such aspects, the commands and information may be provided through a user interface 300, as shown in FIG. 9, discussed in more detail below.

In yet another aspect, a display device 215 can also be connected to the system bus 213 via an interface, such as a display adapter 214. It is contemplated that the QQAB server 30 can have more than one display adapter 214 and the QQAB server 30 can have more than one display device 215. The display device(s) can include, but is not limited to the types of display devices 115 discussed above in connection with the BIM devices 20. Any step and/or result of the methods can be output in any form to an output device. Such output can be any form of visual representation, including, but not limited to, textual, graphical, animation, audio, tactile, and the like. In an aspect, the steps and/or results of the methods performed by the QQAB server 30 can be output in any form to output devices and/or display devices 115 associated with the BIM devices.

For purposes of illustration, application programs and other executable program components, such as the operating systems 105,205 of the BIM devices 20 and QQAB servers 30 respectively, are illustrated herein as discrete blocks, although it is recognized that such programs and components reside at various times in different storage components of and are executed by the respective data processor(s) 103, 203 of the BIM devices 20 and QQAB server 30. An implementation of the applications 101, 201 of the respective BIM devices 20 and QQAB server 30 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. In addition, while certain applications and modules discussed in detail above and herein have been described as being on the BIM devices 20 or QQAB server 30, it is understood that such applications and modules may be found and operating on the opposite or both.

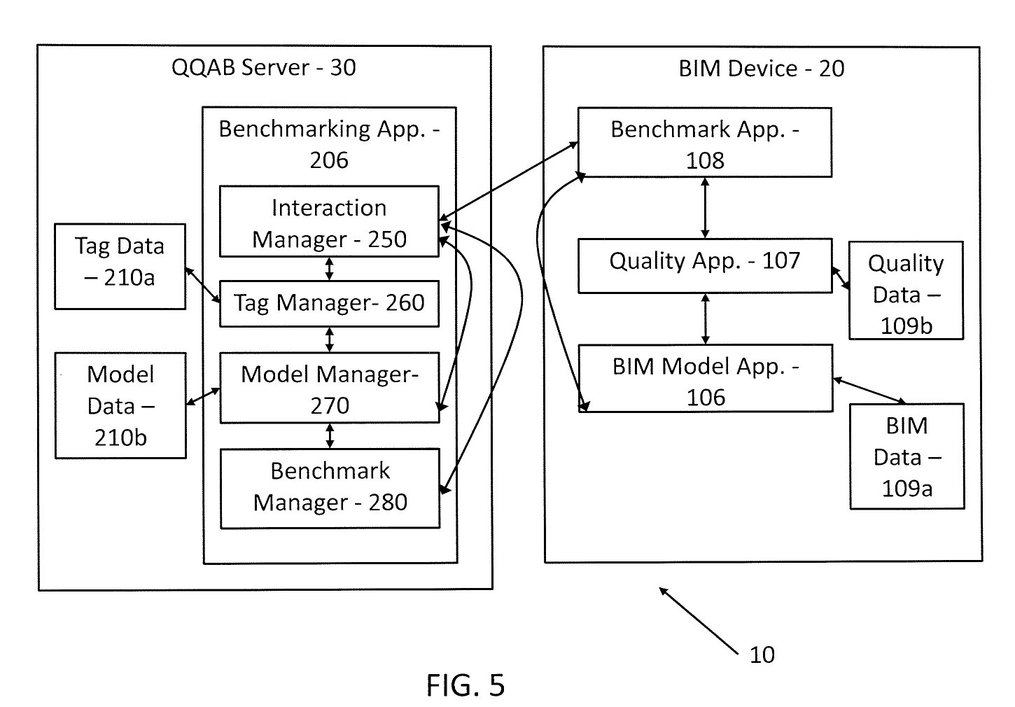

As shown in FIG. 5, the benchmark application 108 of the BIM device 20 and the benchmarking application 206 of the QQAB server 30 of the QQAB system 10 are configured to work with one another to provide a measurable means for the evaluation of BIM models. In an aspect, the benchmarking application 206 of the QQAB server 30, through the use of several modules, is configured to communicate with the benchmark application 108 of the BIM device 20. As illustrated in FIG. 5, the benchmarking application 206 of the QQAB server 30 is configured to have an interaction manager module 250, a tag manager module 260, a model manager module 270, and a benchmark manager module 280, with the interaction manager module 250 configured to communicate and interact with the benchmark application 108 of the BIM device 20, discussed in more detail below.

As illustrated in FIG. 5, the BIM model application 106, the BIM quality check application 107, and the benchmark application 108 are configured to communicate with one another in order to generate BIM models and determine the quality of such BIM models. The BIM model application 106 is configured to generate a BIM model and the associated BIM model data 109a. The BIM model application 106 can include BIM model application and software that is known in the art. In an aspect, the BIM model application 106 can include, but is not limited to, Autodesk Revit Architecture, Graphisoft ArchiCAD, Nemetschek Allplan Architecture, Gehry Technologies-Digital Project Designer, Nemetschek Vectorworks Architect, Bentley Architecture, 4MSA IDEA Architectural Design (IntelliCAD), CADSoft Envisioneer, Softtech Spirit, and RhinoBIM.

A user/stakeholder can utilize the BIM model application 106 to generate and update a BIM model. The BIM model application 106 can generate the BIM model, and the BIM model data 109a associated with the BIM model. In an exemplary aspect, the BIM model data 109a includes the volume and/or area of the facility built represented by the BIM model. In an aspect, the BIM model data 109a can then be stored on the BIM device 20.

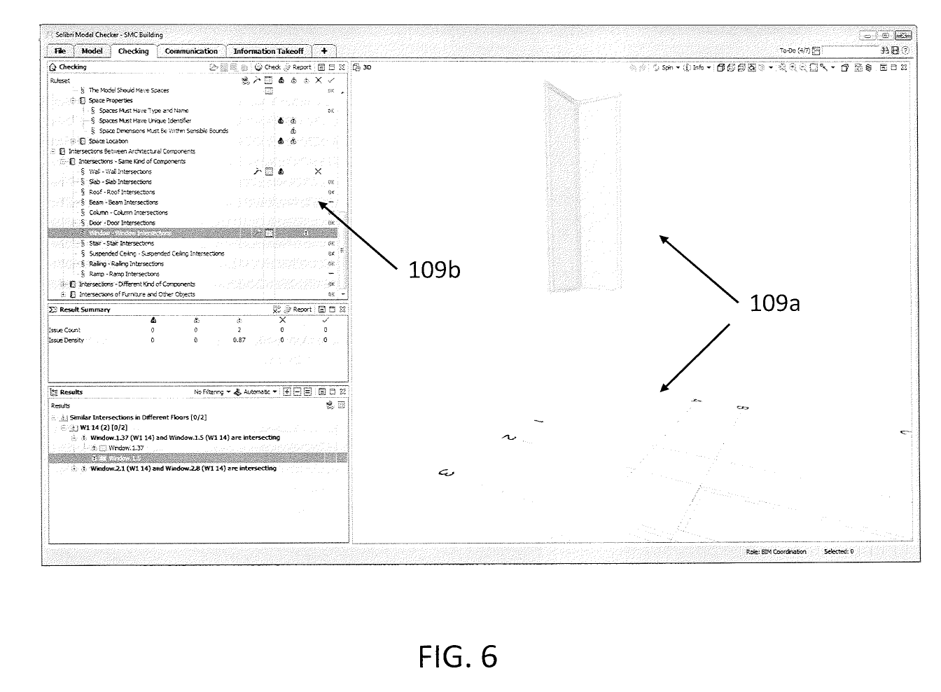

The BIM quality check application 107 is configured to evaluate BIM models and generate quality information for each BIM model as discussed above. The BIM quality check application 107 can include known quality checking applications and software. The BIM quality check application 107 can include, but is not limited to, Solibri Model Checker, Autodesk Navisworks, Tekla BIMsight, and Bentley Navigator. The BIM quality check application 107 can generate a list of issues for the BIM model. FIG. 6 illustrates a screen shot representation of the quality information 109b of a BIM model (and BM model data 109a) after the BIM quality check application 107 has evaluated the BIM model. The quality information 109b can include, but is not limited to, the number of issues found in the BIM model, the types of issues found and the like. FIG. 6 illustrates an issue of windows intersecting, which can lead to problems during actual installation of windows. Further examples of issues include, but are not limited to, clashes (components interfering with other components), overlap (same kind of components e.g. wall overlapping each other in the model), number of components “missing” from the model (e.g. load bearing structures need components on the bottom (components are not hanging in the air) and they need to support some component on top), components of certain type having different dimensions, number of code violence according to a specific building code, and the like.

As shown in FIG. 5, the various applications of the BIM device 20 and the various modules of the benchmarking application 206 of the QQAB server 30 of the QQAB 10 are configured to communicate with one another to perform such process. In an exemplary aspect, the benchmark application 108, the BIM model application 106, and the BIM quality check application 107 of the BIM device 20 are configured to communicate with one another. As discussed above, the BIM model application 106 and the BIM quality check application are responsible for generating and maintaining BIM model data 109a and BIM quality data 109b respectively. In an aspect, the benchmark application 108 of the BIM device 20 is configured to call upon the BIM model application 106 and the BIM quality check application 107 to provide the BIM model data 109a and BIM quality data 109b respectively to the benchmarking application 206 of the QQAB server 30.

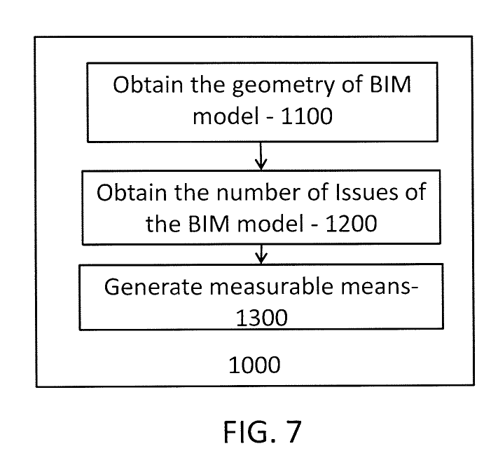

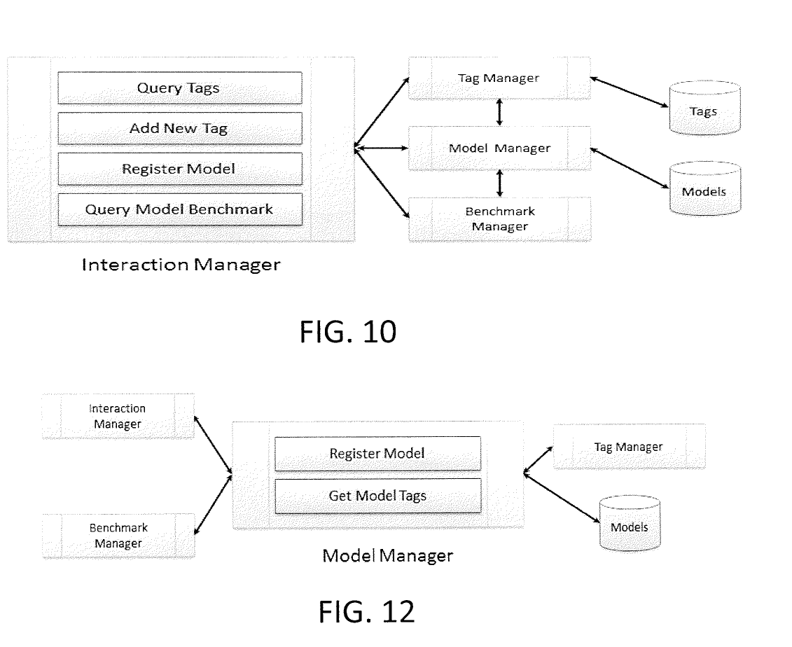

Once the BIM model has been evaluated, the benchmark application 108 of the BIM device 20 can then generate a measureable means (step 1000), as illustrated in FIG. 7. To generate the measurable means, the BIM device 20 can obtain the geometry of the BIM model (step 1100), obtain the number of issues in the BIM model (step 1200), and then generate the measurable means from the geometry of the BIM model and the number of issues (step 1300). In an aspect, the measurable means can include an issue density for the BIM model. In an aspect, the interaction manager module 250, the tag manager module 260, the model manager module 270, and the benchmark manager module 280 are configured to communicate with one another. The interaction manager module 250 configured to manage the interaction between the tag manager module 260, model manager module 270, and the benchmark manager module 280, as illustrated in FIGS. 10, 12, and 14. In addition, the interaction manager module 250 can be configured to communicate with the benchmark application 108 of the BIM device 20.

In an exemplary aspect, the BIM device 20 calls upon the BIM model application 106 to provide the volume (Vs) of the BIM model to the benchmark application 108 (step 1100). Issue density could be computed with respect to area or with respect to volume of the structure represented by the BIM model. Computation of area and volume would depend on systematic geometrical methods used by the BIM model application 106. In such an aspect, the volume can be done to specified number of decimal points if needed.

Once the volume has been obtained, the benchmark application 108 can then call upon the BIM quality check application 107 to provide the number of issues (#ᵢ) (step 1200). Once the volume and issues have been obtained, the benchmark application 108 can generate the issue density (step 1300). The issue density (ρᵢ) can be generated by the following formula:

$${ρ}_{i} = \frac{\# i}{{V}_{s}}$$

Wherein ρᵢ=issue density; (#ᵢ)=the number of issues; Vs=volume of structure. As discussed above, the same formula can be utilized with the volume of the structure being substituted with the area of the structure represented by the BIM model.

In an aspect, once the issue density has been generated, it can be stored with the quality data 109b on the BIM device 20. The issue density can be accessed by/provided to the QQAB server 30 for benchmarking means. The QQAB system 10 has now generated a measuring means (i.e., the issue density) that the user can utilize to compare quality of the BIM model to other BIM models, as discussed in more detail below.

The benchmark application 108 is configured to call upon the BIM model application 106 and the BIM quality check application 107, and the benchmark application 206 of the QQAB server 30, to evaluate the BIM model. In an exemplary aspect, the benchmark application 108 can take the BIM data 109a and the BIM quality data 109b and provide the information to the benchmarking application 206 of the QQAB server 30 for evaluation. In an exemplary aspect, the benchmark application 108 communicates directly with the interaction manager module 250 of the benchmarking application 206, discussed in more detail below.

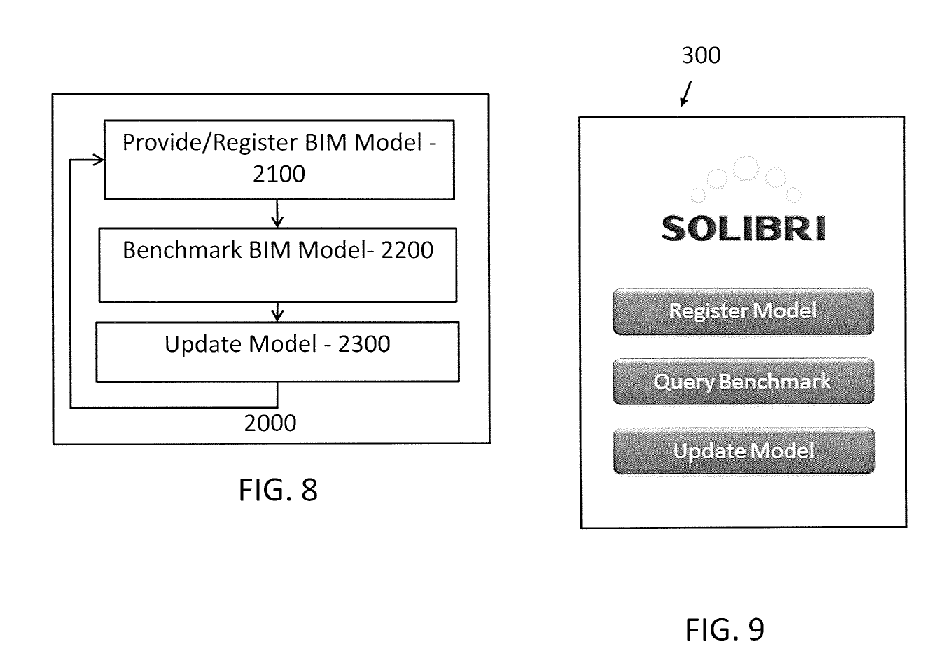

In an aspect, the benchmark application 108 provides a user interface 300 for a user to interact with the benchmark application 206 of the QQAB server 30, as illustrated in FIGS. 9, 16, 18, and 20. In an aspect, the benchmark application 206 can be configured to supply the user interface 300 through the benchmark application 108 of the BIM server 20. The benchmark application 206 can then perform the evaluation of the BIM model. FIG. 8 illustrates an aspect of evaluating the BIM model (method 2000), including the steps registering/providing the BIM model (step 2100), benchmarking the BIM model (step 2200), and updating the BIM Model (step 2300). In an exemplary aspect, the benchmark application 108 can provide the user interface 300 as illustrated in FIG. 9 to perform such steps. In an aspect, once the BIM model data 109a and quality data 109b have been updated (utilizing the BIM model application 106, the BIM quality check application 107, and the benchmark application 108 of the BIM device 20), the BIM model can be provided again to the benchmark application 206 of the QQAB server 30 for further benchmarking, as shown in FIG. 8.

In an aspect, the benchmarking application 206, based upon input from the user, calls upon the interaction manger module 250, the model manager module 260, the tag manager module 270, and the benchmark manager module 280 to register (step 2100) and benchmark (step 2200) the BIM model, as illustrated in FIG. 10. The BIM devices 20 can be utilized to update the BIM model (step 2300). In an aspect, the interaction manager module 250 is configured interact with the user, and to call upon the other modules (model manager 260, tag manager 270, benchmark manager 280) to perform the various steps (2100 and 2200), as shown in FIG. 10. In an exemplary aspect, the interaction manager module 250 can call upon the BIM device 20 to provide the user interface 300 for the user.

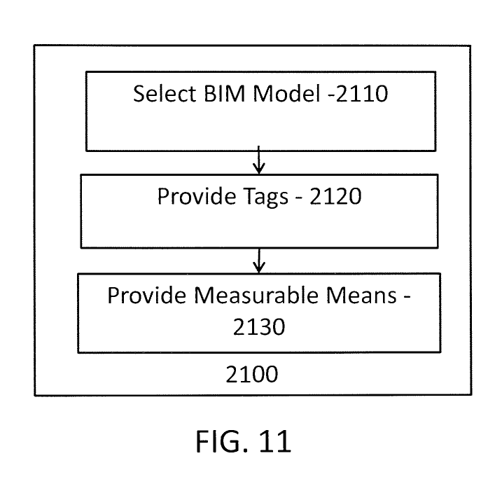

FIG. 11 illustrates an exemplary aspect of how the benchmarking application 206 registers or provides the BIM model (step 2100 of FIG. 8) according to an aspect. To register the BIM model, the user selects the BIM model (step 2110), provides or selects identifying tags that identify the characteristics of the BIM model (step 2120), and then provides the measurable means of the BIM model (2130). In an aspect, this process (step 2100) can be initiated by selecting the “Register Model” tab of the user interface 300 shown in FIG. 9.

In an aspect, the interaction manager module 250 can provide a means for the user to select the BIM model directly and automatically from the BIM device 20 (step 2110). In other aspects, the interaction manager module 250 can be configured for the user to manually provide the BIM model and relative information. Once the BIM module has been selected/identified, the interaction manager 250 can provide the information to the model manager module 270 which can create BIM model data 210b for the QQAB server 30 and save the BIM model data 210b, as shown in FIG. 12. In an aspect, the BIM model data 210b can be stored in the database 218. A BIM model identifier (MODEL_ID) can be generated and saved with the BIM model data 210 for the selected model, as shown in FIGS. 15-16 and 18. The BIM model date 210b includes the measurable means, discussed in detail below.

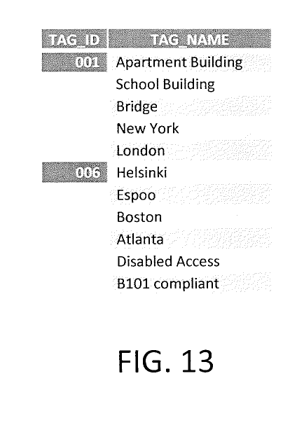

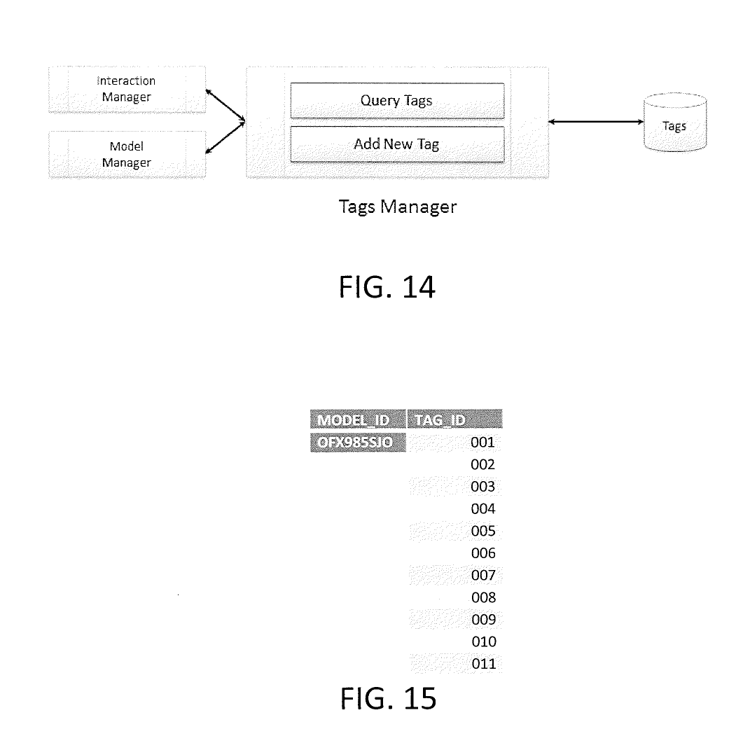

Once the BIM model is selected (step 2110), the benchmarking application 206 can then obtain the identifying tags for the BIM model (step 2120). The tags are utilized to identify certain aspects and/or qualities of the BIM model. FIG. 13 is an illustrative example of the types of tags that can be assigned to a BIM model to identify the characteristics. As shown in FIG. 13, the tags can include a tag identifier (TAG_ID) and a tag description (TAG_NAME). Tag identifiers and corresponding descriptions are not limited to those shown in FIG. 13; the number of tag identifiers and tag descriptions is only limited by the characteristics that can be used to describe components of BIM models. The tag description is used to describe the characteristic that can be associated with the selected BIM model. In an aspect, the interaction manager module 250 can call upon the tags manager module 260 to assist in assigning the tags to the selected BIM model, as shown in FIG. 14. In an aspect, the tags manager module 260 can provide a query function for the user to find tags to assign to the BIM model. In such an aspect, the query function can allow the user to search (via keywords in the description) for tags to assign to the selected BIM model. In another aspect, the tags manager module 260 can be configured to provide a new tag function which allows a user to create new tags for the BIM model.

When a tag is chosen to be assigned to the selected BIM model, the interaction manager module 250 can be configured to call upon the BIM model manager module 270 and the tags manager module 260 to assist in making the corresponding associations with the related data 210 (model data 210b, tag data 210a), as shown in FIGS. 10, 12, and 14. The relationship between the BIM model data 210b and the tag data 210a can be stored in the database 218. In an aspect, the benchmarking application 206 can store the information in a relationship form as shown in FIG. 15. As shown, various models (MODEL_ID) can be associated with different tags (TAG_ID), and various tags (TAGS_ID) can be associated with more than one BIM model. In other words, the table illustrates a ‘many-to-many’ relationship, meaning a model can have many tags and a tag can be associated with many models. For example, as shown in FIG. 15, one BIM model (MODEL_ID IOASA121J) can have five tags (TAG_IDs 002 and 004-7) assigned to it, and another BIM model (MODEL_ID P12OIQW1) can have four tags (TAG_IDs 003, 008-010).

After the tags have been selected for the BIM model (step 2120), the benchmarking application 206 of the QQAB server 30 can then obtain the measurable means of the BIM model (step 2130). In an aspect, the benchmark application 206 can automatically obtain the measurable means from the BIM device 20 once the BIM model has been selected. In another aspect, the benchmark application 206 can be configured for the measurable means to be manually entered by the user via the interaction manager module 250. In an exemplary aspect, the measurable means comprises an issue density. In addition to the issue density, the unit associated with the issue density can be provided as well. For example, if the issue density is indicated as a ratio of issues compared to the volume of the BIM model, it is important to know what unit of volume or area is used for the ratio (e.g., 100 ft³, 1000 m³, 1000 ft², 1000 m²).

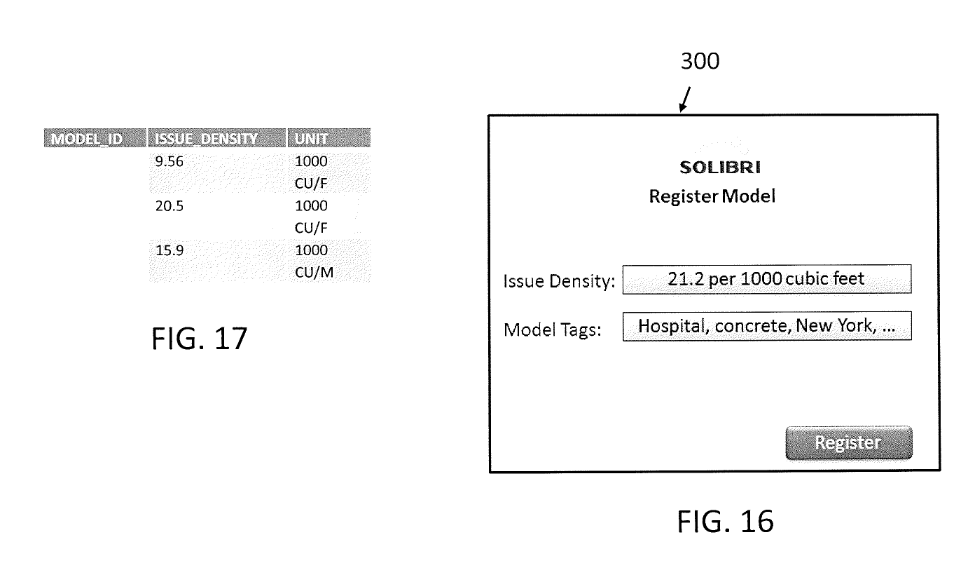

FIG. 16 illustrates a user interface 300 which can assist the user in obtaining the measurable means. Once the measurable means has been obtained, as well as the tags and the BIM module, the measurable means can be assigned to the BIM model (i.e., the BIM model can be assigned). FIG. 17 illustrates an exemplary aspect of relationship of the registered BIM model (MODEL_ID), the issue density (ISSUE_DENSITY), and the units used for the issue density (UNIT). As discussed above, the BIM model data 210b (including the issue density and related units) and the related tag data 210a can be stored in a relational form in the database 218.

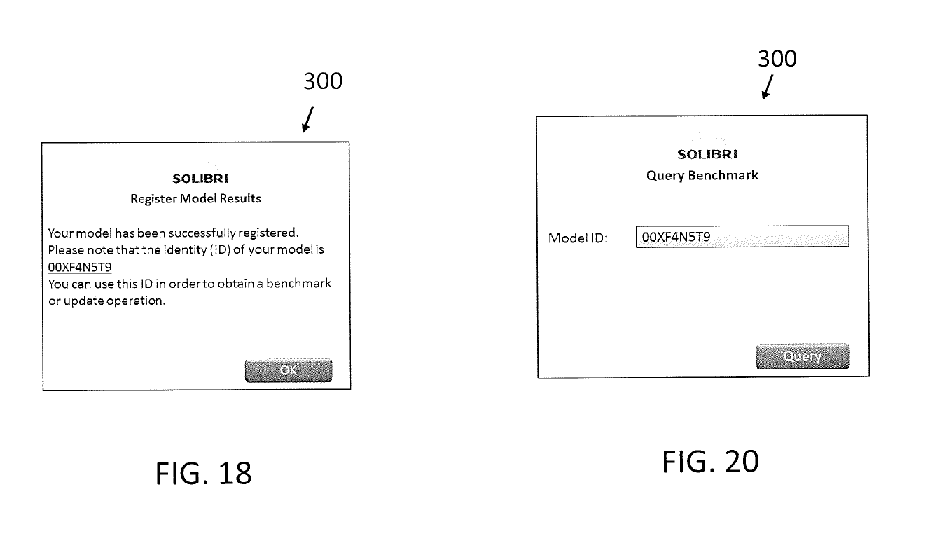

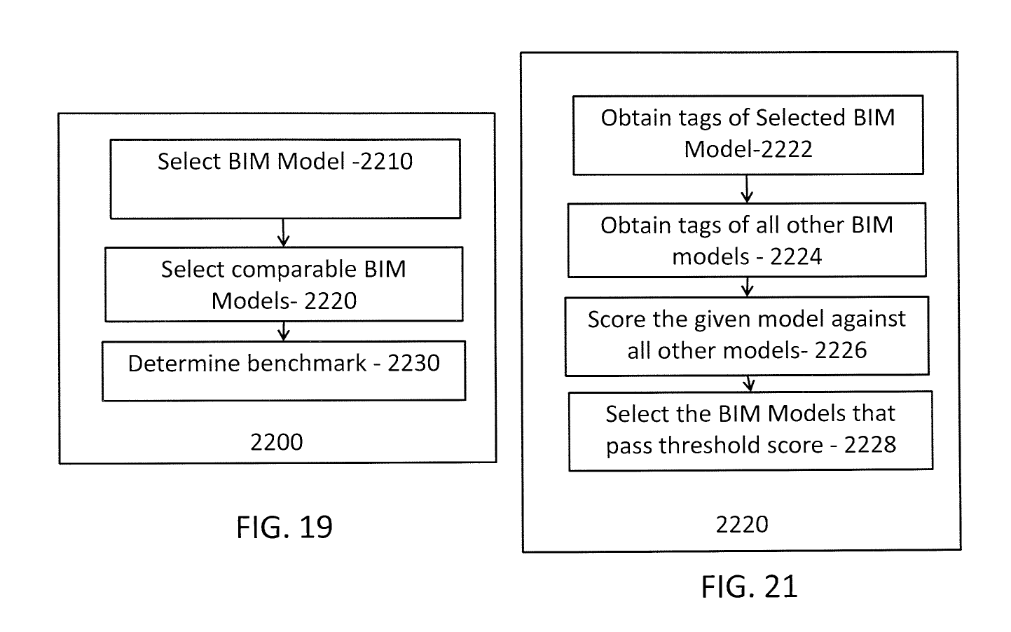

Once the BIM model has been registered (step 2100) (as illustrated by FIG. 18), the benchmark application 206 of the QQAB server 30 can then benchmark the BIM model (step 2200). In an aspect, the benchmarking application 206 can call upon the benchmark manager module 280 to benchmark the selected BIM model. A benchmark gives a user a relative overall quality measure of the BIM model. In an aspect, benchmarking step (step 2200) includes the step of selecting the BIM model for benchmarking (step 2210), selecting the BIM models for comparison (step 2220), and then determining the benchmark (step 2230), as illustrated in FIG. 19.

The user can select the BIM model for benchmarking utilizing the interaction manager module 250 of the benchmark application 206 (step 2210). In an aspect, the user can use a user interface 300 to select the BIM model, as shown in FIG. 20. Once the BIM model has been selected, the benchmark manager module 280 can then select other BIM models for comparison (step 2220). In order for this benchmark to make sense, it is important that the BIM model is compared to other similar BIM models. In an aspect, one way to select the comparable BIM models is to find BIM models that share tags with the selected BIM model.

Various different ways can be used to determine comparable BIM models. In one aspect, a user can require the benchmarking application 206 to use already registered BIM models that share at least one tag with the selected BIM model. In another aspect, the user can require the benchmarking application 206 to find all the registered BIM models that share selected tags with the selected BIM model. In another aspect, the benchmarking application 206 can determine the comparable BIM models to have only the same tags associated with the selected BIM model. The criteria for determining the comparable BIM models can be determined by the user or system administrator, and are not be limited to only those means discussed herein.

In an aspect, the benchmark manager module 280 can be configured to use a classification system to narrow the number of models to be compared, as illustrated in FIG. 21. In an aspect, the benchmark manager module 280 obtains the tags of the selected BIM model (step 2222), obtains the tags of all other registered BIM models (step 2224), scores the selected BIM model against all other registered BIM models based on the tags shared (step 2226), and uses the issue density of the BIM models that have a score that passes the threshold score (step 2228).

First, the benchmark manager module 280, through the interaction manager module 250, can call upon the model manager module 270 and tag manager module 260 to provide the tags of the selected BIM model (step 2222). Similarly, the benchmark manager module 280 can call upon the model manager module 270 and tag manager module 260 to provide the tags of all the other registered BIM models (step 2224).

Once the tags of both the selected BIM model and the other registered BIM models have been acquired, the bench manager module 280 can then determine which of the registered BIM models should be used to create a benchmark for the selected BIM model. In an aspect, the benchmark manager module 280 can score the given BIM model against all the other registered BIM models (step 2226) and then select the BIM models which have a score that equals or exceeds a given threshold (step 2228).

In an exemplary aspect, the benchmark manager module 280 can utilize the following scoring formula to score the registered BIM models (step 2226):

$$score ( a , b ) = 2 \times \frac{\vert common tags \vert}{\vert all tags \vert}$$

In such a formula, a represents the selected BIM model, b represents one of the registered BIM model, |common tags| represent total number of common tags between a and b, and |all tags| represents total counts of tags of a and b combined.

Once the scores have been generated, the benchmark manager module 280 can then compare the scores to a selected threshold to determine which registered BIM models to use for the benchmarking as comparable BIM models (step 2228). In an aspect, the threshold can be set so that only BIM models (b) that share at least half of their respective tags with the selected BIM model (a) are used for the benchmarking. In such an aspect, returning to the formula discussed above, if the score is less than 1, its means that a and b have less than half of the tags common among them. Likewise, if the score is greater than or equal to 1, the registered BIM models have more than half of their respective tags in common. In such an aspect, the benchmark manager module 280 will then select all the registered BIM models that score 1 or more, indicating that the selected models have at least half of the tags common with the selected BIM model (step 2228). In other aspects, the scoring of the BIM models to the selected BIM model can be done using other formulas and other means. In addition, the threshold of the scoring can be adjusted as well. In such aspects, the user/stakeholder, through the BIM device 20, or/and an administrator, through the QQAB server 30, can adjust the threshold to a desired level.

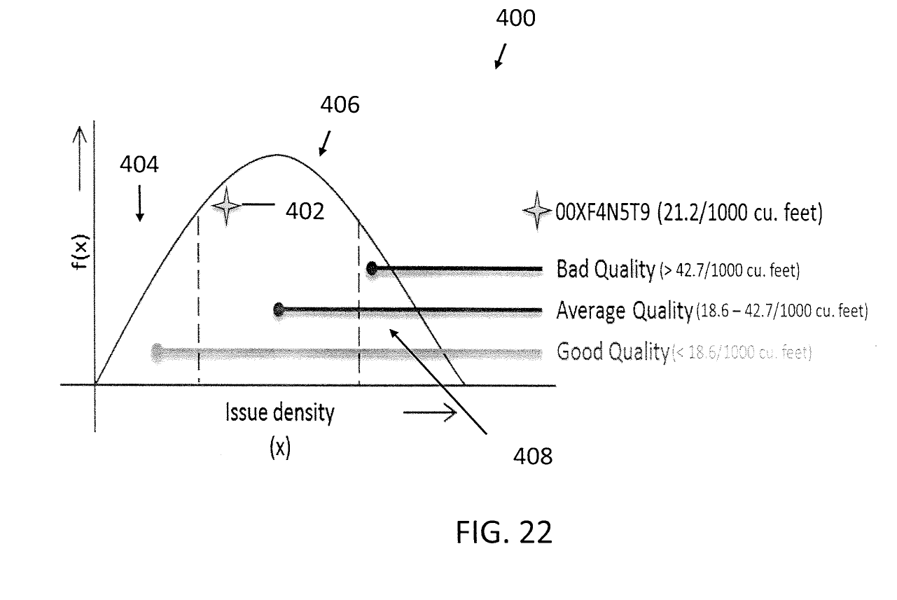

Once the comparable BIM models have been selected (step 2220), the benchmark manager module 280 can then provide a benchmark 400 (step 2230), as illustrated in FIG. 22. In order for the benchmark 400 to be effective, the benchmark 400 must be able to show how the selected BIM model 402 stands in relation to comparable BIM models. In an aspect, the benchmark 400 utilizes the measurable means of the selected BIM model and the comparable BIM models. In an exemplary aspect, the benchmark 400 utilizes issue density. The benchmark 400 can take the form of any means capable of showing a comparison of the measurable means of the selected BIM module and the measurable means of the comparable BIM models. In an exemplary aspect, the benchmark 400 can take the form of a graphical representation, as shown in FIG. 22 other types of relational displays can be utilized by the benchmark 400. In an exemplary aspect illustrated in FIG. 22, the benchmark utilizes a bell curve of each BIM model's issue density. A standard Gaussian formula, shown below, can be used:

$$f ( x ) = \frac{1}{σ \sqrt{2 π}} {e}^{- \frac{{( x - μ )}^{2}}{2 {σ}^{2}}}$$

A Guassian function is used to determine a normal distribution, which assists in creating a reliable benchmark comparison. As shown in FIG. 22, the issue density of the selected BIM model 402 (MODEL_ID 00XF45T9) is highlighted to depict where it stands relative to other comparable BIM models. As shown in FIG. 22, the benchmark 400 can also divide the range of the issue densities of the other BIM models into specific sections (e.g. quartiles) which can indicate if the issue density is of good quality 404, average quality 406, or bad quality 408. These ranges can be based upon determined the desires of the user and/or administrator, or standard statistic practices known in the art.

Having thus described exemplary embodiments of the present invention, those skilled in the art will appreciate that the within disclosures are exemplary only and that various other alternatives, adaptations, and modifications may be made within the scope of the present invention. For example, the methods discussed above are not limited to being performed in the order disclosed. Additionally, the benchmarks can take any form that is capable of showing a comparison of the quality of a selected BIM model against the quality of similar BIM models. Accordingly, the present invention is not limited to the specific embodiments as illustrated herein, but is only limited by the following claims.

What is claimed is:

1. A computer implemented method for benchmarking the quality of a BIM model in comparison to other BIM models, the method comprising;
a. selecting the BIM model;
b. obtaining a measurable means of the selected BIM model; and
c. benchmarking the obtained measurable means of the selected BIM model against measurable means of a plurality of comparable BIM models.

2. The method of claim 1, wherein the obtained measurable means is formed from a relationship between the quality and geometry of the selected BIM model.

3. The method of claim 1, wherein the obtained measurable means comprises an issue density.

4. The method of claim 3, wherein the issue density is determined from the ratio of the number of issues of the selected BIM model to the geometry of the selected BIM model.

5. The method of claim 4, wherein the geometry of the selected BIM model comprises volume.

6. The method of claim 1, wherein the benchmarking the obtained measurable means comprises:
a. selecting the plurality of comparable BIM models from a plurality of registered BIM models; and
b. providing a benchmark of the obtained measurable means against the measurable means of the plurality of the comparable BIM models.

7. The method of claim 6, wherein there is at least one tag assigned to the selected BIM model, wherein selecting the plurality of comparable BIM models from the plurality of registered BIM models utilizes the at least one tag assigned to the selected BIM model.

8. The method of claim 6, wherein selecting the plurality of comparable BIM models from a plurality of registered BIM models comprises:
a. obtaining tags of the selected BIM model;
b. obtaining tags of the plurality of registered BIM models;
c. scoring the selected BIM model against each of the plurality of registered BIM models based upon a comparison of tags shared by the BIM model and each of the plurality of registered BIM models; and
d. selecting the plurality of comparable BIM models from a portion of the plurality of registered BIM models that meet a threshold score after the scoring.

9. The method of claim 6, wherein the benchmark is a graphical representation.

10. The method of claim 9, wherein the measurable means comprises issue densities, and wherein the graphical representation utilizes a bell curve of the issue densities of the selected BIM model and the plurality of comparable BIM models.

11. The method of claim 1, wherein the obtained measurable means of the selected BIM model and the measurable means of the plurality of comparable BIM models comprise issue densities, and wherein the benchmarking further comprises generating a graphical representation utilizing a bell curve of the issue densities of the selected BIM model and the plurality of comparable BIM models with a plurality of quartiles that indicate issue density ranges of quality.

12. The method of claim 1, further comprising the step of updating the selected BIM model after benchmarking the obtained measurable means of the selected BIM model against measurable means of a plurality of comparable BIM models and then repeating steps a-c.

13. A system configured for the quantitative quality analysis and benchmarking of a BIM model, the system comprising;
a. at least one BIM device comprising:
i. a processor;
ii. a display device; and
iii. a system memory comprising a benchmark application configured to generate a measurable means of a selected BIM model; and
b. a QQAR server configured to communicate with the at least one BIM device, the QQAR server comprising:
i. a processor;
ii. a database containing data of a plurality of registered BIM models, wherein the data for each of the plurality of registered BIM models comprises tags and a measurable means; and
iii. a system memory comprising a benchmarking application, the benchmarking application configured to:
A. obtain the measurable means of the selected BIM model from the at least one BIM device;
B. assign tags to the selected BIM model;
C. select a plurality of comparable BIM models from the plurality of registered BIM models based upon the tags of the selected BIM model;
D. generate a benchmark using the measurable means of the selected BIM model compared to the measurable means of the plurality of comparable BIM models; and
E. provide the benchmark to the at least one BIM device for display.

14. The system of claim 13, wherein the at least one BIM device comprises a plurality of BIM devices.

15. The system of claim 13, wherein the measurable means of the selected BIM model comprises an issue density, and wherein the benchmark application configured to generate the issue density of the selected BIM model by identifying a number of issues of the selected BIM model, identifying the volume of the selected BIM model, and determining a ratio of the number of issues per volume unit of the selected BIM model.

16. The system of claim 15, wherein the benchmark comprises a graphical representation of the issue density of the selected BIM model compared to a bell curve of all issue densities for each of the plurality of comparable BIM models.

17. The system of claim 13, wherein the benchmarking application of the QQAR server is configured to select the plurality of comparable BIM models by generating a score for each of the plurality of registered BIM models based upon shared tags between each of the registered BIM model and the selected BIM model, comparing the score to a score threshold, and selecting the registered BIM models with scores matching or exceeding the score threshold.

18. A quantitative quality analysis and benchmarking cloud system configured to provide a benchmark for a selected BIM model, the cloud system configured to communicate with at least one BIM device to receive commands and information regarding the selected BIM model, the cloud system comprising:
a. a processor; obtaining tags of the selected BIM model;
b. a database containing data of a plurality of registered BIM models, wherein the data for each of the plurality of registered BIM models comprises tag data and issue densities;
c. a system memory comprising a benchmarking application, the benchmarking application configured to:
i. obtain the issue density of the selected BIM model from the at least one BIM device;
ii. obtain tag data of the selected BIM model based upon the received commands and information from the at least one BIM device;
iii. select a plurality of comparable BIM models from the plurality of registered BIM models based upon the tags of the selected BIM model;
iv. generate a graphical representation of a relationship of the issue density of the selected BIM model compared to the issue densities of the plurality of comparable BIM models; and
v. provide the graphical representation of the relationship to the at least one BIM device.
